(19) United States
(12) Patent Application Publication
(10) Pub. No.: US 2024/0417993 A1
(43) Pub. Date: Dec. 19, 2024

(54) POLE CAPS AND POLE PROTECTION SYSTEMS

(71) Applicant: Hexion Inc., Columbus, OH (US)

(72) Inventors: Mark D. Clark, Springfield, OR (US); Scott McIntyre, Springfield, OR (US)

(21) Appl. No.: 18/677,147

(22) Filed: May 29, 2024

Related U.S. Application Data
(60) Provisional application No. 63/472,986, filed on Jun. 14, 2023.

(51) Int. Cl. E04H 12/00; E04H 12/02

(52) U.S. Cl. CPC E04H 12/003; E04H 12/02

(57) ABSTRACT

Embodiments of the present disclosure generally relate to pole caps and pole protection systems, and more specifically to pole caps and pole protection systems for use in relation to utility poles. In an embodiment an pole cap is provided. The pole cap includes a body having a peripheral edge and a central portion. The pole cap further includes a plurality of slits in the body, the plurality of slits extending from the peripheral edge and toward the central portion of the body, the body comprising a multilayer structure, the multilayer structure comprising: a polymer layer having a first surface and a second surface opposite the first surface, the second surface for facing the end of the pole; disposed over the first surface of the polymer layer; and a fire resistant composition disposed over the rubber containing layer.

### RELATED APPLICATION DATA

This application claims benefit to U.S. Provisional Application No. 63/472,986, filed Jun. 14, 2023, of which the entire contents of the application are incorporated by reference herein.

### FIELD OF THE INVENTION

Embodiments of the present disclosure generally relate to pole caps and pole protection systems, and more specifically to pole caps and pole protection systems for use in relation to utility poles.

### BACKGROUND

Utility poles, such as power poles, are utilized to support cables, power lines, and wires for the operation of utilities. In many instances, utility poles are made from materials such as wood, metal, concrete, or composite materials that can degrade over time. Pole caps and tops are utilized to protect the top portions of utility poles from the effects of weathering, moisture, ultraviolet rays, and fire, as well as other adverse environmental conditions. In many instances, pole caps are installed on ends of the pole prior to installation at a site. Conventional pole caps can be difficult to install, bulky, and easily damaged. Moreover, typical pole caps can be easily damaged during handling and transportation of poles to work sites.

There is a need for new and improved pole caps and pole protection systems.

### SUMMARY

Embodiments of the present disclosure generally relate to pole caps and pole protection systems, and more specifically to pole caps and pole protection systems for use in relation to, for example, utility poles. Unlike conventional technologies, embodiments of pole caps described herein are easy to install and can fit a wide range of pole end diameters, thereby reducing purchase and installation costs. Moreover, embodiments of pole caps described herein display excellent attachment to pole ends and provide superior protection from handling damage and environmental damage after installation on pole ends. Further, pole protection systems described herein can provide enhanced fire resistance and moisture protection relative to conventional technologies.

In an embodiment, a pole cap for installing on an end of a pole is provided. The pole cap includes a body having a peripheral edge and a central portion; and a plurality of slits in the body, the plurality of slits extending from the peripheral edge and toward the central portion of the body, the body comprising a multilayer structure, the multilayer structure comprising: a polymer layer having a first surface and a second surface opposite the first surface, the second surface for facing the end of the pole; and a rubber containing layer, the rubber containing layer disposed over the first surface of the polymer layer.

In another embodiment, a pole cap for installing on an end of a pole is provided. The pole cap includes a body having a peripheral edge and a central portion. the pole cap further includes a plurality of slits in the body, the plurality of slits extending from the peripheral edge and toward the central portion of the body, the body comprising a multilayer structure, the multilayer structure comprising: a polymer layer having a first surface and a second surface opposite the first surface, the second surface for facing the end of the pole; a rubber containing layer disposed over the first surface of the polymer layer; and a fire resistant composition disposed over the rubber containing layer.

In another embodiment, a pole cap for coupling to an end of a pole is provided. The pole cap includes a body having a peripheral edge and a central portion, the peripheral edge defined by a plurality of edges; and a plurality of slits in the body, the plurality of slits extending from the peripheral edge and toward the central portion of the body, each slit of the plurality of slits extending from each edge of the plurality of edges, the plurality of slits forming a plurality of members, the plurality of members being movable relative to one another into an overlapped configuration, wherein the body comprises a multilayer structure, the multilayer structure comprising: a polymer layer having a first surface and a second surface opposite the first surface, the second surface for facing the end of the pole; and a rubber containing layer having a first surface and a second surface, the second surface of the rubber containing layer disposed over the first surface of the polymer layer; a coating disposed over the first surface of the rubber containing layer, the coating comprising a fire resistant composition, the fire resistant composition comprising: an intumescent compound; and a binder comprising a thermoplastic compound and a thermoset compound.

In another embodiment, a pole protection system is provided. The pole protection system includes a pole cap for mounting to an end of a pole, the pole cap comprising: a body having a peripheral edge and a central portion; and a plurality of slits in the body, the plurality of slits extending from the peripheral edge and toward the central portion of the body, the body comprising a multilayer structure, the multilayer structure comprising: a polymer layer having a first surface and a second surface opposite the first surface, the second surface for facing the end of the pole; a rubber containing layer, the rubber containing layer disposed over the first surface of the polymer layer; and a coating disposed over the first surface of the rubber containing layer, the coating comprising a first fire resistant composition. The pole protection system further includes a wrap for covering a face of the pole, the wrap comprising: a substrate; and a coating disposed over the substrate, the coating comprising a second fire resistant composition, the first and second fire resistant compositions being the same or different.

### BRIEF DESCRIPTION OF THE DRAWINGS

So that the manner in which the recited features of the present disclosure can be understood in detail, a more particular description of the embodiments, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1A is a top view of a pole cap sheet prior to installation on a pole according to at least one embodiment of the present disclosure.

FIG. 1B is a top view of a pole cap sheet prior to installation on a pole illustrating sides of the slits of the pole cap sheet according to at least one embodiment of the present disclosure.

FIG. 2A is a perspective view of a pole cap after installation on a pole according to at least one embodiment of the present disclosure.

FIG. 2B is a top view of the pole cap shown in FIG. 2A according to at least one embodiment of the present disclosure.

FIG. 2C is a side view of a pole cap according to at least one embodiment of the present disclosure.

FIG. 2D is a perspective view of a pole to which a pole cap sheet and corresponding pole cap can be installed according to at least one embodiment of the present disclosure.

FIG. 2E is a perspective view of a pole protection system according to at least one embodiment of the present disclosure.

FIG. 3A is a multilayer structure that forms at least a portion of a body of a pole cap sheet and the associated pole cap according to at least one embodiment of the present disclosure.

FIG. 3B is an exploded view of the layers of the multilayer structure shown in FIG. 3A according to at least one embodiment of the present disclosure.

FIG. 4 is a front perspective view of a multilayer structure that forms at least a portion of a body of a pole cap sheet and the associated pole cap according to at least one embodiment of the present disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to pole caps and pole protection systems. The pole caps can be placed over and attached to an end of, for example, a utility pole to protect the end of the pole weathering, moisture, ultraviolet rays, and fire, as well as other adverse environmental conditions. Pole caps described herein can fit a wide range of pole ends including those pole ends having regular or irregular cross-sectional shapes and sizes. In some examples, and further described below, pole caps of the present disclosure are in the form of a pole cap sheet that can be stamped or cut into various sizes and shapes and then installed onto a pole. The pole cap sheet can include one or more slits extending inward from an outer peripheral edge of the pole cap sheet toward the center of the pole cap sheet. Pole protection systems, as further described below, include a pole cap for an end of a pole and a wrap to cover a face of the pole.

Pole cap sheets, and associated pole caps, described herein can be in the form of a multilayer structure such as a multilayer laminate. For example, pole cap sheets can include at least two layers. The two layers can include a polymer layer and a layer comprising rubberized asphalt. Such two-layer sheets and pole caps can be useful for protection from, for example, moisture and other adverse weather conditions. As another example, pole cap sheets and pole caps of the present disclosure can include at least three layers. The three layers can include a polymer layer, a layer comprising rubberized asphalt, and a layer (or coating) comprising a fire resistant composition. The fire resistant composition can help mitigate damage to poles in the event of fire.

Embodiments described herein can be used for utility poles, such as power poles, transmission poles, telephone poles, hydro poles, and telecommunication poles, that are utilized to support cables, power lines, and wires for the operation of utilities. Such utility poles are typically made from materials such as wood, metal, concrete, or composite materials that can degrade over time. Embodiments of pole caps described herein can be utilized to protect the top portions of utility poles from the effects of weathering, moisture, ultraviolet rays, and fire, as well as other adverse environmental conditions. Embodiments of pole cap systems described herein can be used to protect both the top portion and a face of utility poles.

While embodiments described herein are illustrated with reference to utility poles, various embodiments can be used for any suitable pole, post, piling, column, or other structure or installation which is desired to be protected including both residential and commercial structures and installations. Besides protection of utility poles, such applications for using pole caps and pole protection systems described herein can include, but are not limited to, fencing, docks, piers, retaining walls, sign poles, house pilings and columns, among other applications.

As used herein, a “composition” can include component(s) of the composition, reaction product(s) of two or more components of the composition, a remainder balance of remaining starting component(s), or combinations thereof. Compositions of the present disclosure can be prepared by any suitable mixing process.

### Example Structural Configuration of the Pole Cap and Pole Cap Sheet

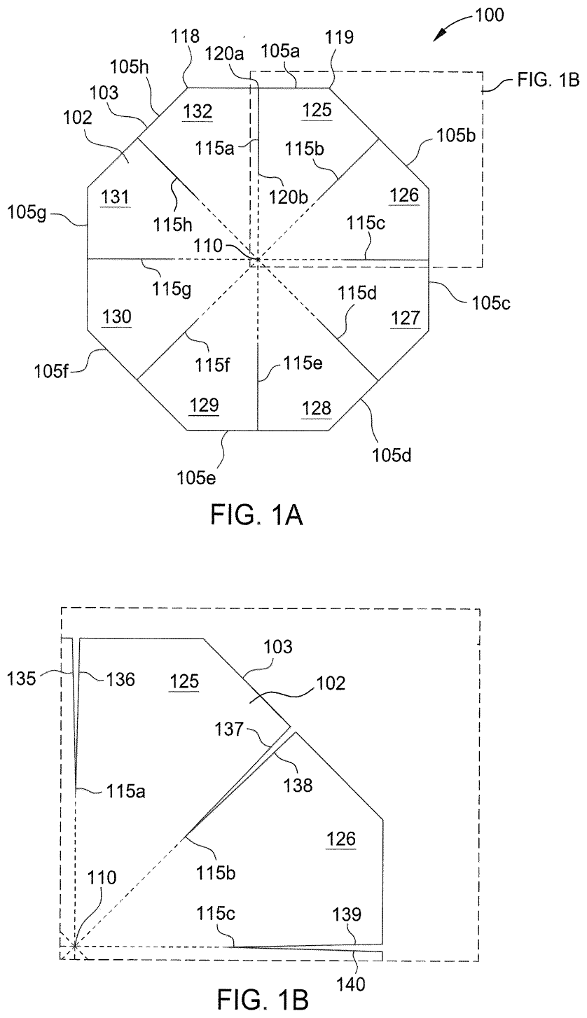

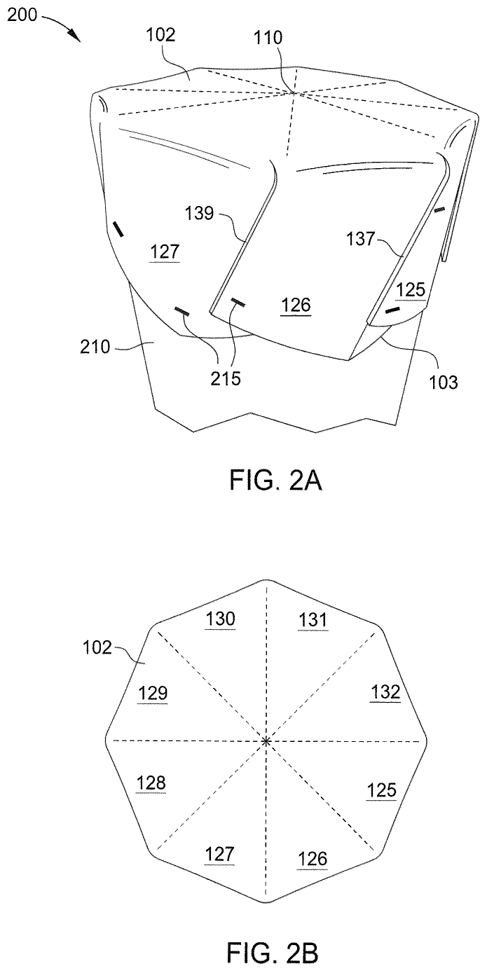

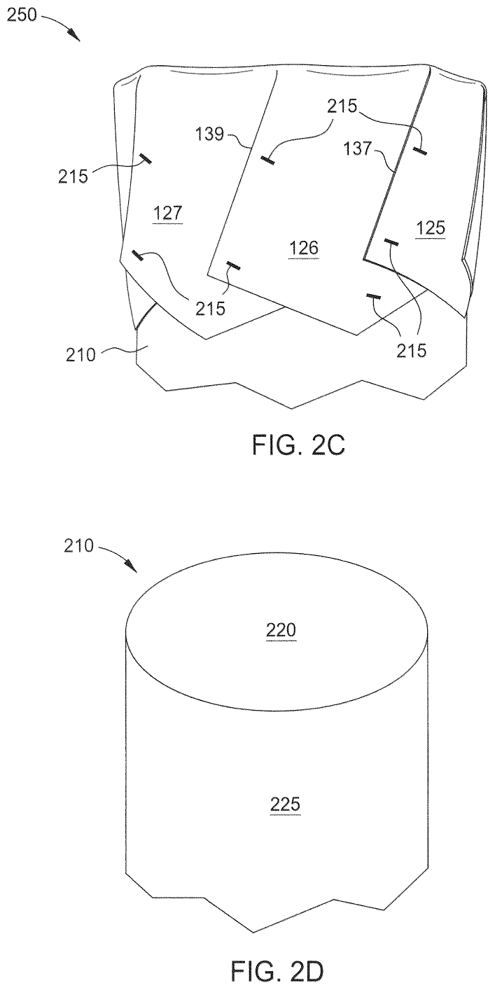

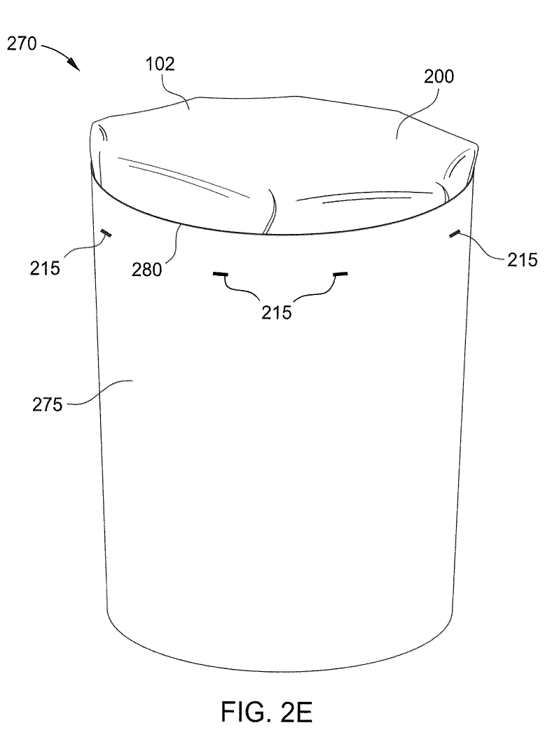

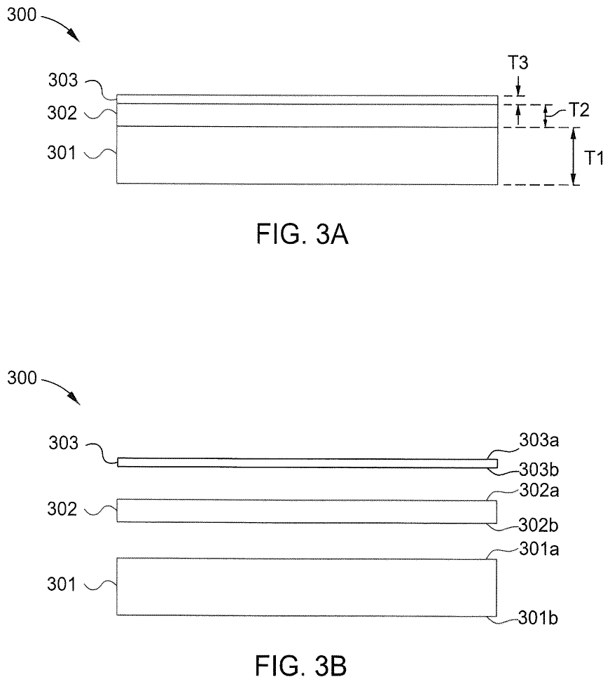

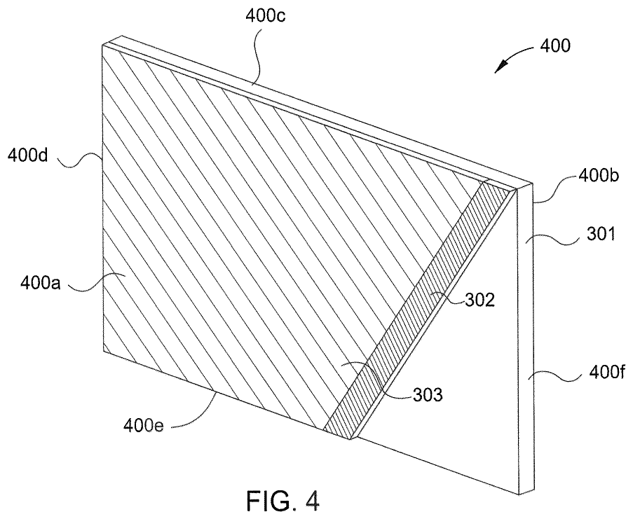

An embodiment of the pole cap sheet 100 is shown in FIG. 1 and the associated pole cap 200 formed therefrom is shown in FIGS. 2A and 2B. Another embodiment of a pole cap 250 formed from a pole cap sheet is shown in FIG. 2C. The multilayer structure shown in FIGS. 3A, 3B, and 4 forms at least a portion of the pole cap sheet 100 and the associated pole cap 200. The multilayer structure can also form at least a portion of the pole cap 250. The features associated with each of the pole cap sheets, pole caps, and multilayer structures are shown for exemplary purposes and may be combined with any of the other features shown on other pole cap sheets, pole caps, or multilayer structures. Generally, the pole sheets can be used directly for installation on a pole end, or can be stamped or cut (for example, laser cut or snipped) into a desired shape and size and then installed on a pole end. In addition to stamping or cutting, the sheets can be formed by molding such as injection molding. Accordingly, descriptions of pole cap sheets apply to descriptions of pole caps, and vice-versa, unless the context clearly indicates otherwise.

FIG. 1A is a top view of a pole cap sheet 100 prior to installation on a pole according to at least one embodiment of the present disclosure. The pole cap sheet 100 includes a body 102 that can be a generally flat sheet of flexible material, though the sheet can be textured as further described below. As shown, the pole cap sheet 100 has an octagonal shape. The pole cap sheet 100, however, can be in the form of a variety of polygonal shapes such as triangle, square, rectangle, quadrilateral, pentagon, hexagon, heptagon, octagon, nonagon, decagon, and so forth. In some embodiments, the polygons can be regular, where the angles of the polygon are equal and all sides (or edges) of the polygon are equal. In at least one embodiment, the polygon can be irregular, where the sides of the polygon are not all equal, the angles of the polygon are not all equal, or a combination thereof. For example, a rectangle is an irregular polygon as it is a four sided polygon having only opposite sides equal but the angles are all equal in measure. Polygons include vertices, where the number of vertices is equivalent to the number of sides. For example, a hexagon has six vertices and six sides; an octagon has eight vertices and eight sides.

The pole cap sheet 100 includes the body 102 and a peripheral edge 103 that extends around the periphery of the pole cap sheet 100. The pole cap sheet 100 (and the associated pole cap 200) includes, or consists, of a multilayer structure as described below. The peripheral edge 103 includes a plurality of edges 105a-105h (or plurality of sides). A plurality of slits 115a-115h (collectively, slits 115) extend inward from the peripheral edge 103 of the pole cap sheet 100 toward a central portion 110 (or center) of the pole cap sheet 100. The slits 115 can be cut into the pole cap sheet using suitable methods.

As shown, the slits 115 can extend only a certain distance inward from the edges 105, such as from point 120a to point 120b. The dashed lines extending toward the central portion 110 of the pole cap sheet 100 from ends of the slits 115 show portions of the pole cap sheet 100 that may not be cut. Alternatively, and in some embodiments, the slits 115 can extend the whole distance (or nearly the whole distance) from the edges 105 to the central portion 110 of the pole cap sheet 100.

As illustrated in FIG. 1A, the slits 115 are positioned at a location along the edges 105. When the body 102 of the pole cap sheet 100 is polygonal in shape, the slits 115 can be positioned or located on one or more vertices of the polygon, between one or vertices of the polygon, or combinations thereof. For illustrative purposes, vertices 118 and 119 are shown, though other vertices are present. The vertices 118 and 119 define the edge 105a. Other vertices define other edges. In the illustrated embodiment, the slit 115a is positioned between the vertices 118 and 119.

In some embodiments, one or more slits 115 can be centered, or substantially centered, between two adjacent vertices of the polygon. Substantially centered means that a slit is within ±10% (or ±5%, or ±2%, or ±1%) a distance of a center point of an edge between two adjacent vertices. For example, slit 115a is formed at a point 120a which is located at a central point along the edge 105a between the adjacent vertices 118 and 119. Here, substantially centered would be at a location that is, for example, ±10% of point 120a.

The number of slits 115 can equal the number of edges 105. However, there is no requirement for the number of slits 115 to be equivalent to the number of edges 105. The number of slits 115 can be less than, the same as, or more than, the number of edges 105. In some examples, when the number of edges 105 is 8, the number of slits 115 is 4, 6, 8, 10, or 12, though other numbers of slits 115 are contemplated. In other examples, when the number of edges 105 is 6, the number of slits 115 is 2, 4, 6, 8, or 10, though other numbers of slits 115 are contemplated. In some embodiments, the number of slits 115 can be 1, 2, 3, 4, 5, 6, 7, 8, 9, 10, 11, 12, 13, 14, 15, 16, 17, 18, 19, or 20, or even more. In at least some examples, the number of slits 115 is within ±4 of the number of edges 105, such as ±3, ±2, or ±1, though other values are contemplated.

Each of the slits 115 is defined by two sides (or edges) as shown in FIG. 1B. For clarity, only the sides of slits 115a, 115b, and 115c are shown. The slit 115a is defined by sides 135, 136, the slit 115b is defined by sides 137, 138, and the slit 115c is defined by sides 139, 140. The side 136 of slit 115a and the side 137 of slit 115b define a first member 125 (or first flap). In a similar manner, the side 138 of slit 115b and the side 139 of slit 115c define a second member 126 (or second flap). The other members (or flaps)—third member 127, fourth member 128, fifth member 129, sixth member 130, seventh member 131, and eighth member 132—are defined in a similar manner. The members 125-132 (or flaps) of the pole cap sheet 100 are movable relative to one another into an overlapped configuration.

Pole cap sheets can be bended, folded, molded, plied, or otherwise deformed into a pole cap. FIG. 2A is a side perspective view of a pole cap 200 after installation of a pole cap sheet on a pole 210 according to at least one embodiment of the present disclosure. FIG. 2B is a top view of pole cap 200 shown in FIG. 2A according to at least one embodiment of the present disclosure. FIG. 2C, discussed below, is a side view of a pole cap 250 after installation a pole cap sheet on a pole 210 according to at least one embodiment of the present disclosure. FIG. 2D is a perspective view of the pole 210 without the pole cap installed.

During installation, and in some embodiments, the pole cap sheet 100 forms into the pole cap 200 where the central portion 110 can be positioned at a location on a pole end 220 of the pole 210 and the peripheral edge 103 of the pole cap sheet 100 can be paired to a face 225 of the pole 210. For example, and as described above, the slits 115 cut into the body 102 and that form the members 125-132 may not be cut the whole distance between the peripheral edge 103 and the central portion 110 of the body 102. In some embodiments, a portion of the body 102 that is not cut can be positioned onto the pole end 220 of the pole 210.

The pole cap sheet 100 can be deformed, bent, or folded to form the pole cap 200 where one or more of the members 125-132 move relative to and passed another member into an overlapped configuration. Here, for example, one of the first member 125 or the second member 126 can move under or over the other member so that the members 125, 126 can overlap. Similarly, one of the second member 126 or the third member 127 can move under or over the other so that the members 126, 127 can overlap, and so forth for the other members 128-132. The pole cap, thus formed, can have a pinwheel-type configuration having an over/under pattern as shown in FIG. 2A where a portion of a member is positioned over and/or under another member. For example, and in some embodiments, a portion of the first member 125 overlaps a portion of the second member 126, a portion of the second member 126 overlaps a portion of the third member 127, and so forth, such that a portion of eighth member 132 can overlap a portion of first member 125. Not all members 125-132 are required to overlap and configurations other than pinwheel are contemplated.

Pole cap sheet 100, and the pole cap formed therefrom (for example, pole cap 200), can be secured to, mounted to, fastened to, coupled to, or otherwise installed on, the pole 210 by any suitable fastener. For example, each of the members 125-132 can, individually, be secured, mounted, fastened, or otherwise coupled to the pole 210, to another member of the pole cap sheet, or combinations thereof, by a fastener 215 such as staples, nails, screws, clips, pins, rivets, bolts, anchors, or combinations thereof, among other fasteners. One or more fasteners 215 can be used for one or more members 125-132. If desired, other portions of the body 102 of the pole cap sheet (and the associated pole cap 200).

Referring to FIG. 2C, the pole cap 250 can be similar to pole cap 200 except that the peripheral edge 103 of the members 125-132 has a triangular pattern. In addition, more fasteners 215 can be used to secure the pole cap 250 to the pole 210. Here, for example, five fasteners 215 are utilized per member, securing two members. In some examples, the fasteners 215 can be positioned in a triangular pattern or another suitable pattern.

As also shown in the embodiments of FIGS. 2A-2D, the central portion 110 of the pole cap sheet 100 can be placed centrally to the pole end 220 of the pole 210 or can be placed at a location off-center of the pole end 220 of the pole 210. The members 125-132 can be pulled down the face 225 of the pole 210 and fastened to the face 225 of the pole 210 as described above. Although the illustrations of FIGS. 2A-2D show the pole 210 as cylindrical, the pole cap sheet 100 and corresponding pole cap 200 (or pole cap 250) described herein can fit a variety of shapes and sizes of poles.

In some examples, the pole cap sheet 100 can have a round shape such as circular shape, oval shape, or elliptical shape, among others. When the pole cap sheet 100 has a round shape, the peripheral edge can be referred to as a peripheral rim. One or more slits can extend radially inward from the peripheral rim and toward the central portion 110 of the pole cap sheet 100. The description for the octagonal-shaped embodiment of FIGS. 1A, 1B, and 2A-2D apply to pole cap sheets of other shapes such as different polygons and round shaped pole cap sheets. Thus, features associated with the pole cap sheets 100 and pole caps 200, 250 of FIGS. 1A, 1B, and 2A-2D, can be extended to pole cap sheets and pole caps of different shapes.

The pole cap sheets described herein can be provided in different sizes where the pole cap sheets can fit a select range of pole sizes. For example, a pole cap sheet can have an area that would be suitable for forming a pole cap that covers a pole end (e.g., pole end 220 of pole 210) having diameters between about 10 cm and about 18 cm. As another example, a pole cap sheet can have an area that would be suitable for forming a pole cap that covers a pole end having diameters from about 18 cm to about 28 cm. In another example, the a pole cap sheet can have an area that would be suitable for forming a pole cap that covers a pole end having diameters between about 28 cm to about 36 cm. In another example, the a pole cap sheet can have an area that would be suitable for forming a pole cap that covers a pole end having diameters between about 36 cm to about 46 cm.

FIG. 2E is a perspective view of a pole protection system 270 that includes a pole cap (for example, pole cap 200 or pole cap 250) and a wrap 275 according to at least one embodiment of the present disclosure. A sheath, a sleeve, a mat, a roll, or other structure can be used as an alternative to the wrap 275.

The wrap 275 (or sheath, sleeve, mat, roll, or other structure) can include, or be made from, a substrate and a fire resistant composition. Suitable substrates for use in the wrap 275 include those substrates comprising, consisting of, or consisting essentially of, wood, fiberglass, glass, metal, clay, shale, concrete, foam, a polymer, an elastomer, a cellular solid, or combinations thereof. Wood and lignocellulose substrates can include, but are not limited to, solid lumber, particle board, plywood, medium density fiberboard, hardboard, parallel strand lumber, oriented strand board, strawboard, or combinations thereof, among others. The substrate of the wrap 275 can be flexible or moldable substrate. Alternatively, the substrate of the wrap 275 can be a rigid substrate. The substrate of the wrap 275 can be porous or non-porous. In some examples, the substrate of the wrap 275 can have a mesh structure (or open-cell structure). Such mesh or open-cell structures can have voids. The voids can enable the fire resistant composition to expand and protect the pole 210. Alternatively, the substrate can have a closed-cell structure. Fire resistant compositions (or intumescent compositions) that can be used for the wrap 275 include those described below. The fire resistant composition that can be used for the wrap 275 can be the same or different fire resistant composition used for pole cap sheets (and associated pole caps) described herein.

The pole protection system 270 can cover an end of a pole and extend along a whole length of a pole or a portion of the pole. For clarity, certain features of the pole cap 200 are not shown. The wrap 275 can be layered around the pole one or more times. The wrap 275 can be secured to, mounted to, fastened to, coupled to, or otherwise installed on, the pole cap 200, the pole 210, or both, by fastener 215 such as staples, nails, screws, clips, pins, rivets, bolts, anchors, or combinations thereof, among other fasteners. An end 280 of the wrap 275 can overlap at least a portion of the body 102 of the pole cap 200.

For installation, the pole cap (for example, pole cap 200) can be secured to, mounted to, fastened to, coupled to, or otherwise installed on, the pole 210 prior to the wrap 275, or vice versa. The wrap 275 can be wrapped around (or layered around) the pole 210 one or more times such as two or more times. The pole protection system 270 can be secured to the pole 210 prior to installation of the pole 210 at a work site. Alternatively, the pole protection system 270 can be secured to a pole 210 that is already installed at the work site, for example, a pole that is already installed in the ground.

### Example Multilayer Structure of the Pole Cap Sheet/Pole Cap

As described above, at least a portion of the body 102 of pole cap sheets (and the associated pole caps) described herein can be in the form of a multilayer structure such as a multilayer laminate. One or more layers of the multilayer structure can be in the form of a coating, a film, or other similar structure. In some embodiments, the multilayer structure which forms at least a portion of the body 102 of pole cap sheets (and associated pole caps) can include two or more layers. The two or more layers can include a polymer layer and a layer comprising rubberized asphalt. These multilayer structures can be useful for protection from, for example, moisture and other adverse weather conditions. In some embodiments, the body 102 of pole cap sheets (and the associated pole caps) described herein can include three or more layers. The three or more layers can include a layer (or a coating) comprising a fire resistant composition, a layer comprising rubberized asphalt and a polymer layer. The fire resistant composition can help mitigate damage to poles in the event of fire.

FIG. 3A is a multilayer structure 300 that forms at least a portion of a body 102 of pole cap sheet and associated pole caps described herein, according to at least one embodiment of the present disclosure. One or more of the layers of the multilayer structure 300 may be a coating. FIG. 3B is an exploded view of the multilayer structure shown in FIG. 3A showing the surfaces of layers of the multilayer structure 300. Although the embodiments shown in FIGS. 3A and 3B include three layers, it is contemplated that more or less layers can be utilized. For example, a two-layer structure comprising a polymer layer and a layer comprising rubberized asphalt.

The multilayer structure 300 includes a polymer layer 301 having a first surface 301a and a second surface 301b that is opposite the first surface 301a. The polymer layer can serve as a waterproofing layer. The polymer layer 301 is also referred to as a base layer. The polymer layer 301 can include, or consist of, various suitable polymers such as those polymers formed from olefins such as alpha-olefins, dienes, trienes, as well as polymers formed from epoxides or other polymerizable functional groups. In some embodiments, polymers used for at least a portion of the polymer layer 301 comprises an olefin. For purposes of the present disclosure, when a polymer is referred to as comprising an olefin, the olefin present in the polymer is the polymerized form of the olefin. Similarly, when a polymer is referred to as comprising a monomer and/or a monomer, the monomer and/or comonomer present in the polymer is the polymerized form of the monomer and/or comonomer. Likewise the use of the term polymer is meant to encompass homopolymers and copolymers, where copolymers include any polymer having two or more chemically distinct monomers. For the purposes of this disclosure, the term “polypropylene” as used herein means polymers containing propylene as monomers, it can be homopolypropylene or copolymer of propylene and alpha-olefin comonomers. For the purposes of this disclosure, the term “polyethylene” as used herein means polymers containing ethylene as monomers, it can be homopolyethylene or copolymer of ethylene and alpha-olefin comonomers.

Suitable olefins include substituted or unsubstituted C2 to C40 alpha olefins, such as C2 to C20 alpha olefins, such as C2 to C12 alpha olefins, such as ethylene, propylene, butene, pentene, hexene, heptene, octene, nonene, decene, undecene, dodecene, and isomers thereof. The polymers can be homopolymers or copolymers. In at least one embodiment, the polymer is formed from ethylene and an optional comonomer comprising one or more of C3 to C40 olefins, such as C3 to C20 olefins, such as C5 to C12 olefins. In at least one embodiment, a polymer useful to form at least a portion of the polymer layer 301 is formed from propylene and an optional comonomer comprising one or more of ethylene or C4 to C40 olefins, such as C4 to C20 olefins, such as C4 to C12 olefins. The olefin monomers can be unsubstituted or substituted, linear or branched, partially saturated or fully unsaturated, cyclic or acyclic. The olefin monomers may be strained or unstrained, monocyclic or polycyclic, and may optionally include heteroatoms and/or one or more functional groups. The olefins can include an aromatic group. For example, olefins include styrene and vinyltoluene.

An unsubstituted olefin refers to an olefin that consists of hydrogen and carbon atoms only. A substituted olefin refers to an olefin where at least one atom of the olefin has been substituted with at least one heteroatom or heteroatom-containing group, such as one or more elements from Group 13-17 of the periodic table of the elements, such as halogen (F, Cl, Br, or I), O, N, Se, Te, P, As, Sb, S, B, Si, Ge, Sn, Pb, and the like, such as C(O)R, C(C)NR₂, C(O)OR, NR*₂, OR, SeR, TeR, PR₂, AsR₂, SbR₂, SR, SOₓ (where x=2 or 3), BR₂, SiR₃, GeR₃, SnR₃, PbR₃, and the like, where R is, independently, hydrogen or hydrocarbyl, or where at least one heteroatom has been inserted within the R group. “Hydrocarbyl” refers to a group consisting of hydrogen and carbon atoms only.

Illustrative, but non-limiting, examples of C2 to C40 olefin monomers and optional comonomers include ethylene, propylene, butene, pentene, hexene, heptene, octene, nonene, decene, undecene, dodecene, isoprene, chloroprene, butadiene, 1,3-hexadiene, 1,4-hexadiene, cyclopentadiene, dicyclopentadiene, 4-vinylcyclohex-1-ene, methyloctadiene, 1-methyl-1,6-octadiene, 7-methyl-1,6-octadiene, 1,5-cyclooctadiene, norbornadiene, ethylidene norbornene, 5-vinylidene-2-norbornene, 5-vinyl-2-norbornene, norbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, isomers thereof, their respective homologs and derivatives, or combinations thereof. Other olefin monomers are contemplated.

Other monomers useful to form polymers that are useful as at least a portion of polymer layer 301 include, but are not limited to: vinyl halides such as vinyl chloride; unsaturated nitrile monomers such as acrylonitrile; diesters of a carboxylic acid monomer such as diesters of maleic acid or fumaric acid, for example, dibutyl maleate or dibutyl fumarate; alpha, beta-unsaturated carboxylic acid monomers such as acrylic, methacrylic, crotonic, maleic or fumaric acids and derivatives thereof, for example, alpha, beta-unsaturated amide monomer such as acrylamide or methacrylamide. More than one monomer can be utilized to form polymers that are useful as at least a portion of polymer layer 301.

In some embodiments, the polymer layer 301 comprises polypropylene, polyethylene, ethylene-propylene copolymer, or combinations thereof.

A thickness (for example, T1 in FIG. 3) of the polymer layer 301 can be any suitable thickness.

The multilayer structure 300 further includes a layer 302 that comprises, or consists of, any suitable material such as rubber, an elastomer, rubberized asphalt, or combinations thereof. Other materials are contemplated. The layer 302 has a first surface 302a and a second surface 302b opposite the first surface 302a. As shown, the second surface 302b of layer 302 is disposed over, or is adjacent to, the first surface 301a of the polymer layer 301. When the layer 302 contains rubber, rubberized asphalt, and similar materials, the layer 302 is interchangeably referred to as a rubber-containing layer.

Rubberized asphalt includes rubber that is ground.

A thickness (for example, T2 in FIG. 3) of the layer 302 can be any suitable thickness.

The multilayer structure 300 further includes a coating 303 that comprises, or consists of, a fire resistant composition. The coating 303 can serve to impart fire resistance to the pole cap. The coating 303 is interchangeably referred to as a fire resistant coating or an intumescent coating. The coating 303 can be in the form of a layer, film, or other structure. Fire resistant compositions useful to form at least a portion of coating 303 are described below.

The coating 303 has a first surface 303a and a second surface 303b opposite the first surface 303a. As shown, the second surface 303b of coating 303 is disposed over, or is adjacent to, the first surface 302a of the layer 302. The coating 303 can be a continuous coating or a mesh coating. In some examples, the coating 303 can substantially coat, or at least partially coat, at least one surface of the layer 302 (e.g., first surface 302a).

A dry-coating thickness (for example, T3 in FIG. 3) of the coating 303 can be any suitable dry coating thickness. Each of the foregoing numbers can be preceded by the word “about,” “at least about,” “less than about,” or “more than about,” and any of the foregoing numbers can be used singly to describe an open-ended range or in combination to describe a close-ended range.

Although only one polymer layer 301, only one layer 302, and only one coating 303 are shown, the multilayer structure 300 can include a plurality of polymer layers, a plurality of layers 302, a plurality of coatings 303, or combinations thereof, in any suitable pattern. Such suitable patterns include, but are not limited to, an ABC pattern, an ABABC pattern, an ABCABC pattern, ABCAC pattern, CABC, among many other iterations, where A is polymer layer 301, B is layer 302, and C is coating 303.

For example, a second coating comprising a fire resistant composition can be disposed over, or be adjacent to, the second surface 301b of the polymer layer 301. In these and other embodiments, a second polymer layer can be disposed over or adjacent to the second coating comprising a fire resistant composition. There is no requirement for an equivalent number of A layers (for example, polymer layer 301) to B layers (for example, layer 302). There is also no requirement that the number of C layers (for example, coating 303) be equivalent to the number A layers, the number of B layers, or both. That is, the number of A layers, B layers, and C layers can be the same or different.

Layer(s), coating(s), or combinations thereof, of the multilayer structure can be coupled to or adhered to one another by using suitable materials including, but not limited to, binders and adhesives. The binders and adhesives can act as a binding agent, such as a phenolic resin, or a bonding agent, such as an epoxy resin. Binders and adhesives that are useful include: a hot-melt adhesive; a resin, such as an epoxy resin, a polyvinyl acetate resin, ethylene vinyl acetate copolymer (EVA) resin, a phenolic resin (for example, a phenol-formaldehyde resin), an amino resin, a polyurethane resin, an isocyanate-based resin, combinations thereof, among others. The binders, adhesives, or other materials can be dried or cured under ambient conditions; heat, light, electromagnetic radiation, or combinations thereof can be used for drying or curing the binders, adhesives, or other materials.

Non-limiting, commercially available examples of binders and adhesives include Vinnapas EP 6300 which is a vinyl acetate and ethylene copolymer dispersion available from Wacker Chemie Ag.

The adhesive or binding agent cures or dries and adheres the one or more layers together. For example, an adhesive, binding agent, or both can be used to adhere layer 302 to the polymer layer 301. In some embodiments, one or more of the polymer layer 301, the layer 302, or the coating 303, can be coupled without the use of an adhesive. For example, the fire resistant composition used to form the coating 303 can be introduced to the layer 302 in a liquid state and upon the curing or drying of the fire resistant composition, the coating 303 forms and adheres to layer 302.

In some examples, the coating 303 can be formed on one or more layers of the multilayer structure by introducing or applying a fire resistant composition to one or more layers using any suitable method such as brush coating, spray coating, roller coating, dip coating, curtain coating, and combinations thereof. The fire resistant composition can then be cured or dried by suitable methods to form the coating 303. Curing or drying can be performed using suitable methods such as utilizing curing ovens at elevated temperatures. Heating is optional as curing or drying can be performed at ambient conditions. Besides heating, other curing and drying methods include, but are not limited to, light, electromagnetic radiation, hot-melt, styrene-acrylics, epoxies, among others.

FIG. 4 is a front perspective view of a multilayer structure 400 that forms at least a portion of the body 102 of a pole cap sheet and the associated pole cap according to at least one embodiment of the present disclosure. Multilayer structure 400 can represent the multilayer structure 300, pole cap sheets described herein (for example, pole cap sheet 100), and when installed on a pole, can represent pole caps described herein (for example, pole cap 200 and pole cap 250). Top surface 400a can be an outward-facing surface, the surface that faces an exterior of the pole to which the pole cap sheet (or associated pole cap) is to be affixed. Bottom surface 400b can be an inward-facing surface, the surface that faces the pole end to which the pole cap sheet (or associated pole cap) is to be affixed is to be affixed.

Typically, a surface of the coating 303 (for example, first surface 303a) forms at least a portion of the top surface 400a and a surface of the polymer layer 301 (for example, second surface 301b) though embodiments described herein are not so limited.

The multilayer structure 400 is shown so as to view the individual layers (or coatings). However, it should be understood that the layers (or coatings) can extend across the other layers or coatings. Although the embodiment shown in FIG. 4 includes three layers, it is contemplated that more or less layers can be utilized. For example, a two-layer structure comprising two of a polymer layer, a layer comprising rubberized asphalt, or a coating, can be utilized.

In some embodiments, one or more of polymer layer 301, layer 302, or coating 303 can include, individually, features or elements such as channels, embossments, protrusions, indentations, grooves, perforations, recesses, or cutouts. Other features or elements are contemplated. The features or elements can be located on (or positioned on) one or both surfaces of the polymer layer 301, layer 302, or coating 303, or combinations thereof, such as first surface 301a, second surface 301b, first surface 302a, second surface 302b, first surface 303a, second surface 303b, or combinations thereof. In relation to the multilayer structure 400 of FIG. 4, the top surface 400a, bottom surface 400b, first edge 400c, second edge 400d, third edge 400e, fourth edge 400f, or combinations thereof can include, individually, such features or elements.

The features or elements can be fabricated onto the multilayer structure with an omnidirectional relief pattern or a unidirectional relief pattern. The features or elements can be patterned as a grid, an array, an egg-crate pattern, or be random. The features or elements can be patterned in any suitable shape such as rounded, pyramids, squares, rectangles, squares, squiggles or other geometric or random shapes. The features and elements facilitate water and air flow, thereby improving moisture permeability, improving ventilation, and reduce mold.

In some embodiments, patterned features or elements can be positioned on or located on at least a portion of one or more of polymer layer 301, layer 302, or coating 303. In at least one embodiment, patterned features or elements are positioned on or located on an entirety of a surface of one or more of the polymer layer 301, layer 302, or coating 303. In some embodiments, patterned features or elements can be positioned on a portion, but not all, of a surface of one or more of the polymer layer 301, layer 302, or coating 303.

In relation to the multilayer structure 400 of FIG. 4, patterned features or elements can be positioned on or located on at least a portion of top surface 400a, bottom surface 400b, first edge 400c, second edge 400d, third edge 400e, fourth edge 400f, or combinations thereof. In at least one embodiment, patterned features or elements are positioned on or located on an entirety of top surface 400a, bottom surface 400b, first edge 400c, second edge 400d, third edge 400e, fourth edge 400f, or combinations thereof. In some embodiments, patterned features or elements can be positioned on or located on a portion, but not all, of top surface 400a, bottom surface 400b, first edge 400c, second edge 400d, third edge 400e, fourth edge 400f, or combinations thereof.

As described above, the coating 303 comprises, consists of, or consists essentially of, a fire resistant composition. The fire resistant composition is interchangeably referred to as an intumescent composition. Intumescent coating compositions are substances that expand as a result of heat exposure, thus increasing in volume and decreasing in density. A description of example fire resistant compositions that can be used with embodiments described herein is now provided.

The fire resistant composition can include an intumescent (such as expandable graphite) and a binder. In some embodiments, the fire resistant composition can optionally include additives, water, or combinations thereof.

One or more intumescents can be utilized in fire resistant compositions. The intumescent(s) can include expandable graphite. Expandable graphite is a synthesized intercalation compound of graphite that expands when heated. Expandable graphite is formed by treating crystalline graphite, which is composed of stacks of parallel planes of carbon atoms, with intercalants such as sulfuric acid and nitric acid. Since no covalent bonding exists between the planes of the carbon atoms, the intercalant can be inserted between them. This allows the intercalant to be positioned within the graphite lattice. When the intercalated graphite is exposed to heat or flame, the inserted molecules decompose and release gases. The graphite layer planes are pushed apart by the gas and the graphite expands up to 300 times its original thickness, its bulk density is lowered, and its surface area is increased. This results in a low-density thermal insulation layer. Expandable graphite can also be referred to as expandable flake graphite, intumescent flake graphite, or expandable flake.

Expandable graphite can be available in a variety of particle size distributions. This varies with the manufacturer and grade. For example, NYAGRAPH® 251 has a particle distribution of the following: below 150 microns-1-5%, 150 microns-300 microns: 9-15%, 300 microns-710 microns: 79-85%, and over 710 microns: 1-5%.

The intumescent(s) can include an expandable graphite compound having a mean particle size in the range of about 300 μm to about 1,000 μm, such as from about 375 μm to about 950 μm, such as from about 400 μm to about 800 μm, such as from about 450 μm to about 700 μm, such as from about 500 μm to about 600 μm. The intumescent(s) can include an expandable graphite compound having a mean particle size in the range of about 0.5 μm to about 250 μm, such as from about 5 μm to about 200 μm, such as from about 20 μm to about 175 μm, such as from about 50 μm to about 150 μm, such as from about 75 μm to about 125 μm.

The intumescent(s) can include (a) a first expandable graphite compound having a mean particle size in the range of from 300 microns to 1000 microns; and (b) a second expandable graphite compound having a mean particle size in the range of from 0.5 microns to 250 microns. A weight ratio of the first expandable graphite compound to the second expandable graphite compound can be about 10:1 to about 1:10, such as from about 5:1 to about 1:5, such as from about 4:1 to about 1:4, such as from about 3:1 to about 1:3, such as from about 2:1 to about 1:2, such as about 1:1, though higher or lower weight ratios are contemplated.

Examples of expandable graphite can include, but are not limited to, Nyagraph 35, Nyagraph 251, Nyagraph 351 (commercially available from Nyacol Nano Technologies, Inc., Ashland, Mass.), Grafguard 160-50N, and Grafguard 200-100N (commercially available from Graf Tech International, Brooklyn Heights, Ohio).

A total amount of the intumescent(s) (for example, a total amount of expandable graphite compound(s)) in a fire resistant composition can be from about 1 wt % to about 50 wt %, such as from about 5 wt % to about 40 wt %, such as from about 10 wt % to about 30 wt %, such as from about 15 wt % to about 25 wt %, based on the total weight of the fire resistant composition. The total weight of the fire resistant composition does not exceed 100 wt %. In some embodiments, a total amount, in wt %, of the intumescent(s) in a fire resistant composition, based on the total weight of the fire resistant composition, can be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, or ranges thereof, though higher or lower amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

Fire resistant compositions useful to form at least a portion of coating 303 also include a binder or a plurality of binders. Binders can perform several functions. The binder can act as a matrix in which the other components of the fire resistant composition are dispersed. The binder can also bind the coating 303 to one or more of layer 302 or polymer layer 301 of the multilayer structure 300. Additionally, the binder can contribute to the insulating char layer formed by the expansion of the fire resistant composition. Unlike conventional, commercially available compositions rated for fire resistance which include inorganic compounds and minerals as a binder, the fire resistant compositions described herein include organic materials.

In some embodiments, the binder includes, consists of, or consists essentially of, at least one thermoplastic compound, at least one thermoset compound, at least one adhesive, or a combination thereof. The thermoplastic compound can be present as a dispersion. The dispersion can be prepared by any suitable method known to those skilled in the art. In various embodiments, the dispersion is prepared via an emulsion.

Illustrative, but non-limiting, examples of thermoplastic compounds that can be used include ethylene vinyl acetate copolymer, polyvinyl acetate, poly(methyl acrylate), poly(methyl methacrylate), poly(ethyl acrylate), poly(ethyl methacrylate), poly(n-butyl acrylate), poly(n-butyl methacrylate), poly(isobutyl acrylate), poly(isobutyl methacrylate), poly(tert-butyl acrylate), poly(tert-butyl methacrylate), poly(2-hydroxyethyl acrylate), poly(2-hydroxyethyl methacrylate), poly(2-hydroxypropyl acrylate), poly(2-hydroxypropyl methacrylate), poly(2-ethylhexyl acrylate), poly(2-ethylhexyl methacrylate), or combinations thereof. Commercially available thermoplastic compounds include Multibond 1P2 (which is a crosslinking polyvinyl acetate available from Franklin Adhesives and Polymers) and Covinax FR-A 707 (a styrene acrylic thermoplastic compound commercially available from Franklin International), among others.

The thermoset compound is optionally present in the fire resistant composition as a dispersion. The thermoset dispersion can be prepared by any suitable method known to those skilled in the art, such as by slow addition of a resin into a system that contains an emulsifying agent.

Illustrative, but non-limiting, examples of thermoset compounds that can be used include, phenol formaldehyde resin, phenol resorcinol formaldehyde resin, urea formaldehyde resin, melamine formaldehyde resin, melamine reinforced urea formaldehyde resin, isocyanate reinforced urea formaldehyde resin, resorcinol formaldehyde resin, polyacrylic latex resin, isocyanate resin, an organopolysiloxane, ethylene glycol, a bisphenol-A epoxy resin, a bisphenol-F epoxy resin, an unsaturated polyester, polyurethane, or combinations thereof. Commercially available thermoset compounds include Cascorez resins (Hexion, Inc.) such as Cascorez NA 707. Other commercially available thermoset compounds can include, but are not limited to, XB-91MO (Hexion, Inc.), which is a phenolic thermoset compound, Cascophen phenol formaldehyde resin, Cascophen phenol resorcinol formaldehyde resin, Cascomel melamine formaldehyde resin, and Casco urea formaldehyde resin, among others, each of which is commercially available from Hexion, Inc. The thermoset compound can be free of paragum or include paragum.

In some examples, the binder includes one or more of ethylene vinyl acetate copolymer (EVA), urea formaldehyde resin, melamine formaldehyde resin, melamine reinforced urea formaldehyde resin, phenol resin, phenol formaldehyde resin, phenol resorcinol formaldehyde resin, polyurethane, or combinations thereof.

A total amount of binder in fire resistant composition can be from about 1 wt % to about 80 wt %, such as from about 5 wt % to about 75 wt %, such as from about 10 wt % to about 70 wt %, such as from about 15 wt % to about 65 wt %, such as from about 20 wt % to about 55 wt %, such as from about 25 wt % to about 50 wt %, such as from about 30 wt % to about 45 wt %, based on the total weight of the fire resistant composition. In some examples, the total amount of binder in a fire resistant composition can be from about 15 wt % to about 70 wt %, such as from about 25 wt % to about 60 wt %, such as from about 35 wt % to about 55 wt %, based on the total weight of the fire resistant composition. The total amount of binder in the fire resistant composition is the total weight of the thermoplastic compound(s) and the thermoset compound(s).

In some embodiments, a total amount (in wt %) of binder in a fire resistant composition, based on the total weight of the fire resistant composition, can be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80, or ranges thereof, though higher or lower amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

As described above, the binder can include at least one thermoplastic compound and at least one thermoset compound. A weight ratio of the thermoplastic compound(s) to the thermoset compound(s) in the binder can be in the range of about 10:1 to about 1:3, such as from about 8:1 to about 1:2.5, such as from about 6.5:1 to about 1:2, such as from about 6:1 to about 1:1.5, such as from about 5:1 to about 1:1, such as from about 3:1 to about 1.5:1. In some embodiments, the weight ratio of the thermoplastic compound to the thermoset compound in the binder can be 10:1, 9.5:1, 9:1, 8.5:1, 8:1, 7.5:1, 7:1, 6.5:1, 6:1, 5.5:1, 5:1, 4.5:1, 4:1, 3.5:1, 3:1, 2.5:1, 2:1, 1.5:1, 1:1, 1:1.5, 1:2, 1:2.5, or 1:3, or ranges thereof, though other weight ratios are contemplated. Each of the foregoing numbers can be preceded by the word “about,” “at least about,” “less than about,” or “more than about,” and any of the foregoing numbers can be used singly to describe an open-ended range or in combination to describe a close-ended range.

Fire resistant compositions useful to form at least a portion of coating 303 can also include a variety of optional additives, depending on the application. Illustrative, but non-limiting, examples of optional additives can include a catalyst, a blowing agent, a defoamer, a rheological modifier, a dispersant, a pigment, a fire barrier additive, a coalescing agent, a viscosity reducer, a water softener, a toxic gas absorbing material, an absorbent promoter, a wetting agent, a nucleating agent, an accelerator, a filler, a buffer, a reinforcing additive, a surfactant, a thickener, and/or combinations thereof in any suitable amounts or proportions. Some of the optional additives can have multiple purposes in the fire resistant compositions. For example, magnesium oxide can serve as both a pigment and a fire barrier additive.

The fire resistant composition can include one or more catalysts. Catalysts can be useful to assist with the intumescent expansion of the composition. Illustrative, but non-limiting, examples of catalysts include perchloric acid, hydroiodic acid, hydrobromic acid, sulfuric acid, hydrochloric acid, nitric acid, sulfurous acid, phosphoric acid, nitrous acid, sulfonic acid, hydrochloric acid, sulfuric acid, phosphoric acid, formic acid, acetic acid, maleic acid, malic acid, tartaric acid, citric acid, ammonium phosphates, ammonium polyphosphates, metal phosphates, metal polyphosphates, paratoluene sulfonic acid, or combinations thereof. One or more types of catalysts can be used with fire resistant compositions. Commercially available catalysts can include, but are not limited to, Exolit AP 422 (an ammonium polyphosphate, Clariant International Ltd). Ammonium polyphosphate can also act as a blowing agent.

When a catalyst is used, a total amount of catalyst(s) in a fire resistant composition can be from about 0.5 wt % to about 25 wt %, such as from about 1 wt % to about 20 wt %, such as from about 2 wt % to about 15 wt %, such as from about 3 wt % to about 12 wt %, such as from about 4 wt % to about 10 wt %, such as from about 6 wt % to about 8 wt %, based on the total weight of the fire resistant composition. In some embodiments, the total amount (in wt %) of catalyst(s) in a fire resistant composition, based on the total weight of the fire resistant composition, can be 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 21.5, 22, 22.5, 23, 23.5, 24, 24.5, or 25, or ranges thereof, though higher or lower amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

Fire resistant compositions can include one or more blowing agents. Blowing agents can be useful for expanding the binder in order to increase the thickness of the fire resistant composition. The blowing agent can also serve to dilute the concentrations of combustible gasses that are released when a wood material (e.g., a utility pole made of wood) burns. Examples of blowing agents that can be used include, but are not limited to, melamine, urea, butyl urea, alumina trihydrate, dicyandiamide, benzene sulfonyl-hydrazide, azobisisobutyronitrile, 1,1-azobisformamide, 4,4′ oxybis(benzene sulfonhydrazide), dinitroisopentamethylene tetraamine, or combinations thereof. One or more types of blowing agents can be used with fire resistant compositions described herein.

In various embodiments, the melamine used can be Melafine (available from OCI Nitrogen). Blowing agents can include solid carbonate species such as calcium carbonate, sodium carbonate, sodium bicarbonate, potassium carbonate, or combinations thereof. Liquid carbonates can also be used as blowing agents such as propylene carbonate and solutions or slurries of calcium carbonate sodium carbonate, sodium bicarbonate, potassium carbonate, or combinations thereof. Commercially available blowing agents can also include, but are not limited to, Microna 3 (calcium carbonate) commercially available from Columbia River Carbonates, and Imasco 5H (limestone) commercially available from Imasco Minerals Inc.

When a blowing agent is used, a total amount of blowing agent(s) in a fire resistant composition can be from about 1 wt % to about 35 wt %, such as from about 5 wt % to about 30 wt %, such as from about 10 wt % to about 25 wt %, such as from about 15 wt % to about 20 wt %, based on the total weight of the fire resistant composition. In some embodiments, the total amount (in wt %) of blowing agent(s) in a fire resistant composition, based on the total weight of the fire resistant composition, can be 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, or 35, or ranges thereof, though higher or lower amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

Fire resistant compositions can include one or more defoamers. In some embodiments, a total amount of defoamer(s) in fire resistant compositions described herein can be from about 0 wt % to about 11 wt %, such as from about 0 wt % to about 10 wt %, such as from about 0.05 wt % to about 8 wt %, such as from about 0.05 wt % to about 2 wt %, such as from about 0.1 wt % to about 1.5 wt %, such as from about 0.2 to about 1 wt % based on the total weight of the fire resistant composition. In at least one embodiment, the total amount (in wt %) of defoamer(s) in a fire resistant composition, based on the total weight of the fire resistant composition, can be 0, 0.01, 0.03, 0.05, 0.1, 0.2, 0.25, 0.5, 0.75, 1, 1.5, 2, 2.5, 3, 3.5, 4, 4.5, 5, 5.5, 6, 6.5, 7, 7.5, 8, 8.5, 9, 9.5, 10, 10.5, or 11, or ranges thereof, though other amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

Illustrative, but non-limiting, examples of defoamers can include Byk-037 (a volatiles-free, silicone-containing defoamer commercially available from BYK-Chemie GmbH).

Fire resistant compositions can include one or more rheological modifiers. Rheological modifiers can serve to prevent flotation of the particles during, for example, agitation and mixing. In some embodiments, a total amount of rheological modifier(s) in a fire resistant composition can be from about 0 wt % to about 10 wt %, such as from about 0.01 wt % to about 10 wt %, 0.25 wt % to about 10 wt %, such as from about 0.5 wt % to about 7 wt %, such as from about 0.75 wt % to about 5 wt %, such as from about 1 wt % to about 2 wt % based on the total weight of the fire resistant composition. In some examples, the total amount of rheological modifier(s) in a fire resistant composition can be from about 0.01 wt % to about 1 wt %, based on the total weight of the fire resistant composition. In at least one embodiment, the total amount (in wt %) of rheological modifier(s) in a fire resistant composition, based on the total weight of the fire resistant composition, can be 0, 0.1, 0.25, 0.5, 0.75, 1, 1.5, 2, 2.5, 3, 3.5, 4, 4.5, 5, 5.5, 6, 6.5, 7, 7.5, 8, 8.5, 9, 9.5, or 10, or ranges thereof, though other amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

Illustrative, but non-limiting, examples of rheological modifiers can include Thixol 53L (a liquid acrylic thickener or rheological modifier, commercially available from Arkema), Rheotech 3800 (a thickener or rheological modifier commercially available from Arkema), Natrosol 250 HR (a thickener or rheological modifier commercially available from Ashland Global Specialty Chemicals Inc.), or combinations thereof.

Fire resistant compositions can include one or more dispersants. In some embodiments, a total amount of dispersant(s) in a fire resistant composition can be from about 0 wt % to about 10 wt %, such as from about 0.1 wt % to about 8 wt %, such as from about 0.25 wt % to about 3 wt %, such as from about 0.5 wt % to about 2 wt %, such as from about 0.75 wt % to about 1.5 wt % based on the total weight of the fire resistant composition. In at least one embodiment, the total amount (in wt %) of dispersant(s) in a fire resistant composition, based on the total weight of the fire resistant composition, can be 0, 0.25, 0.5, 0.75, 1, 1.5, 2, 2.5, 3, 3.5, 4, 4.5, 5, 5.5, 6, 6.5, 7, 7.5, 8, 8.5, 9, 9.5, or 10, or ranges thereof, though other amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

Illustrative, but non-limiting, examples of dispersants can include Disperbyk-190 (commercially available from BYK-Chemie GmbH).

Fire resistant compositions can include one or more pigments. In some embodiments, a total amount of pigment(s) in a fire resistant composition can be from about 0 wt % to about 10 wt %, such as from about 0.5 wt % to about 8 wt %, such as from about 1 wt % to about 5 wt %, based on the total weight of the fire resistant composition. In at least one embodiment, the total amount (in wt %) of pigment(s) in a fire resistant composition, based on the total weight of the fire resistant composition, can be 0, 0.25, 0.5, 0.75, 1, 1.5, 2, 2.5, 3, 3.5, 4, 4.5, 5, 5.5, 6, 6.5, 7, 7.5, 8, 8.5, 9, 9.5, or 10, or ranges thereof, though other amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

Illustrative, but non-limiting, examples of pigments can include magnesium oxide (commercially available from Sigma Aldrich), iron oxide (commercially available from Sigma Aldrich), titanium oxide (commercially available from Sigma Aldrich), calcium carbonate (commercially available from Sigma Aldrich), or combinations thereof.

Materials used for pigments can also be utilized as a fire barrier additive. Fire barrier additives that can be used include, but are not limited to, oxides (for example magnesium oxide and iron oxide). When a fire barrier additive is used, a total amount of fire barrier additive(s) in a fire resistant composition can be from about 0 wt % to about 10 wt %, such as from about 0.5 wt % to about 8 wt %, such as from about 1 wt % to about 5 wt %, based on the total weight of the fire resistant composition. In at least one embodiment, the total amount (in wt %) of fire barrier additive(s) in a fire resistant composition, based on the total weight of the fire resistant composition, can be 0, 0.25, 0.5, 0.75, 1, 1.5, 2, 2.5, 3, 3.5, 4, 4.5, 5, 5.5, 6, 6.5, 7, 7.5, 8, 8.5, 9, 9.5, or 10, or ranges thereof, though other amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

Fire resistant compositions can include one or more coalescing agents. In some embodiments, a total amount of coalescing agent(s) in a fire resistant composition can be from about 0 wt % to about 10 wt %, such as from about 0.5 wt % to about 7.5 wt %, such as from about 1 wt % to about 5 wt %, based on the total weight of the fire resistant composition. In at least one embodiment, the total amount (in wt %) of coalescing agent(s) in a fire resistant composition, based on the total weight of the fire resistant composition, can be 0, 0.25, 0.5, 0.75, 1, 1.5, 2, 2.5, 3, 3.5, 4, 4.5, 5, 5.5, 6, 6.5, 7, 7.5, 8, 8.5, 9, 9.5, or 10, or ranges thereof, though other amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

Illustrative, but non-limiting, examples of coalescing agents can include 2,2,4-trimethyl-1,3-pentanediol monoisobutyrate (also known as Texanol commercially available from Sigma Aldrich and NX 795 commercially available from Synthomer PLC).

One or more water softeners can additionally be present in fire resistant compositions. Water softeners can include sodium polyphosphate (commercially available from Sigma Aldrich). In some embodiments, a total amount of water softener(s) in a fire resistant composition can be from about 0 wt % to about 10 wt %, such as from about 0.5 wt % to about 7.5 wt %, such as from about 1 wt % to about 5 wt %, based on the total weight of the fire resistant composition. In at least one embodiment, the total amount (in wt %) of water softener(s) in a fire resistant composition, based on the total weight of the fire resistant composition, can be 0, 0.25, 0.5, 0.75, 1, 1.5, 2, 2.5, 3, 3.5, 4, 4.5, 5, 5.5, 6, 6.5, 7, 7.5, 8, 8.5, 9, 9.5, or 10, or ranges thereof, though other amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

In some embodiments, a total amount of optional additive(s) in fire resistant compositions described herein can be about 40 wt % or less, such as about 30 wt % or less, such as about 20 wt % or less, such as about 15 wt % or less, such as about 10 wt % or less, such as from about 0 wt % wt about 10 wt %, such as from about 0.5 wt % to about 8 wt %, such as from about 1 wt % to about 6 wt %, such as from about 2 wt % to about 5 wt %, such as from about 3 wt % to about 4 wt %. In some embodiments, the total amount (in wt %) of optional additive(s) in a fire resistant composition, based on the total weight of the fire resistant composition, can be 0, 0.25, 0.5, 0.75, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, or ranges thereof, though higher or lower amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

In some embodiments, fire resistant compositions described herein can include water. The water can serve as a diluent, a viscosity reducer, or both. An amount of water in fire resistant compositions described herein can be about 40 wt % or less, such as from about 0 wt % to about 30 wt %, such as from about 5 wt % to about 20 wt %, such as from about 10 wt % to about 18 wt % or from about 5 wt % to about 15 wt %. In at least one embodiment, the total amount (in wt %) of water in a fire resistant composition, based on the total weight of the fire resistant composition, can be 0, 0.25, 0.5, 0.75, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, or 30, or ranges thereof, though other amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

To prepare a fire resistant composition, the components to be used—for example, the expandable graphite and binder component(s)—are mixed together in any suitable order, combination, or sub-combination. In some embodiments, a fire resistant composition is prepared by mixing the expandable graphite, catalyst, blowing agent, thermoplastic compound, and thermoset compound in any order, combination or sub-combination. The fire resistant composition can be dried or cured to form at least a portion of the coating 303.

Optional additives, described above, can also be introduced to the mixture. Water can also be utilized, if desired, to aid in mixing the components.

In some embodiments, the fire resistant composition comprises, consists of, or consists essentially of one or more of the following: a) a first expandable graphite compound having a mean particle size in the range of about 300 microns to about 1000 microns; b) a second expandable graphite compound having a mean particle size in the range of about 0.5 microns to about 250 microns with a first expandable graphite compound to second expandable graphite compound weight ratio in the range of about 4:1 to about 1:4; c) a binder comprising: i) a thermoplastic compound; and ii) a thermoset compound with a thermoplastic compound to thermoset compound weight ratio in the range of about 10:1 to about 1:3; d) a catalyst; and e) a blowing agent.

In at least one embodiment, the first expandable graphite compound and second expandable graphite compound are present in a fire resistant composition in a combined amount in the range of about 1 wt % to about 50 wt %, based on the total weight of the fire resistant composition. In some embodiments, the binder is present in a fire resistant composition in the range of about 10 wt % to about 80 wt %, based on the total weight of the fire resistant composition. In at least one embodiment, the blowing agent is present in a fire resistant composition in the range of about 1 wt % to about 20 wt %, based on the total weight of the fire resistant composition. In some embodiments, the catalyst is present in a fire resistant composition in the range of about 0.5 wt % to about 20 wt %, based on the total weight of the composition.

### Example Methods

Embodiments described herein also relate to methods of making pole cap sheets described herein. Pole cap sheets described herein can be pre-formed or pre-fabricated into a variety of sizes and shapes such as those used for pole cap sheets or pole caps. Layers of the pole cap sheets can be cut into specific shapes and dimensions prior to coupling (or adhering) the layers or coatings to one another. Alternatively, the finished pole cap sheet can be cut into specific shapes and dimensions.

Methods of making or forming a pole cap sheet described can include forming a layer (or coating 303) comprising, consisting of, or consisting essentially of, a fire resistant composition. The coating 303 is formed by curing or drying a fire resistant composition using suitable methods such as utilizing curing ovens at elevated temperatures. Heating is optional as the curing or drying can be performed at ambient conditions. Besides heating, other curing and drying methods include, but are not limited to, light, electromagnetic radiation, hot-melt, styrene-acrylics, epoxies, among others. Curing or drying can be performed for a suitable period such as about 24 hours to about 72 hours, though when heat is used, the period can be less than 24 hours. The layer 302 can be formed on coating 303 by pressure bonding a precursor used for layer 302 to the coating 303. Pressure bonding can be performed using suitable apparatus and methods for gas-pressure bonding, thermocompression bonding, or other suitable methods. Additionally, or alternatively, prior to fully drying or curing the fire resistant composition, the precursor used for layer 302 can be disposed on the fire resistant composition, and then the coating having the precursor for layer 302 disposed thereon can be cured or dried.

The method further includes applying a polymer layer 301 to the layer 302 and securing (for example, binding, bonding, or adhering) the layers together. Securing can be performed using suitable materials including, but not limited to, binders and adhesives. The binders and adhesives can act as a binding agent, such as a phenolic resin, or a bonding agent, such as an epoxy resin. Binders and adhesives that are useful include, but are not limited to: a hot-melt adhesive; a resin, such as an epoxy resin, a polyvinyl acetate resin, ethylene vinyl acetate copolymer (EVA) resin, a phenolic resin (for example, a phenol-formaldehyde resin), an amino resin, a polyurethane resin, an isocyanate-based resin, combinations thereof, among others. The binders, adhesives, or other materials can be dried or cured under ambient conditions. Heat, light, electromagnetic radiation, or combinations thereof can be used for drying or curing the binders, adhesives, or other materials. Non-limiting, commercially available examples of binders and adhesives include Vinnapas EP 6300 which is a vinyl acetate and ethylene copolymer dispersion available from Wacker Chemie Ag.

As described above, one or more surfaces of the multilayer structure 400 (or an associated pole cap sheet 100), such as the top surface 400a, bottom surface 400b, first edge 400c, second edge 400d, third edge 400e, fourth edge 400f, or combinations thereof can include, individually, texturing, features, or elements such as channels, embossments, protrusions, indentations, grooves, perforations, recesses, or cutouts, among others. Such texturing, features, or elements can be created by using any suitable method such as pressboard molding, stamping, engraving, among other techniques.

If desired, a pole cap sheet described herein can be fabricated with a fastener to facilitate fastening or mounting to a pole or installation. Additionally, or alternatively, holes can be disposed in pole cap sheets described herein. The holes can facilitate use of nails or screws to secure the pole cap sheets to a pole or installation.

The wrap 275 can be formed by coating a substrate with a fire resistant composition described herein in any suitable manner. Examples of coating methods include, but are not limited to brush coating, spray coating, roller coating, and curtain coating.

After production of the pole cap sheet 100 at a manufacturing site, the produced pole cap sheet 100 (and the associated pole cap formed therefrom) can be secured to a pole end 220 of the pole 210 prior to installation of the pole 210 at the work site. Alternatively, the pole cap sheet 100, and pole cap formed therefrom, can be secured onto a pole end of a pole 210 already installed at the work site, for example, a pole already installed in the ground. One or more fasteners 215, described above, are used for securing the pole cap sheet 100 and the associated pole cap formed therefrom, to the pole 210. Securing of an article to a pole can refer to mounting, fastening, coupling, or otherwise installing an article on the pole.

Similarly, after manufacturing of the components of the pole protection system 270 (for example, pole cap sheet 100 and wrap 275), each of the components of the pole protection system 270, individually, can be secured on the pole 210 prior to, or after, installation of the pole 210 at the work site.

The following examples are put forth so as to provide those of ordinary skill in the art with a complete disclosure and description of how to make and use embodiments of the present disclosure, and are not intended to limit the scope of embodiments of the present disclosure. Efforts have been made to ensure accuracy with respect to numbers used but some experimental errors and deviations should be accounted for.

### EXAMPLES

Non-limiting example of pole cap sheets were prepared. The example articles included a polymer layer, a layer of rubberized asphalt, and a layer (or coating) of a fire resistant composition. The polymer layer is a polypropylene.

The components used to form a non-limiting example of a fire resistant composition are shown in Table 1. The fire resistant composition was used to form the coating of the pole cap sheet.

TABLE I

| | Ingredients | |
|---|---|---|
| | Part I | Parts by weight |
| Water | Water | 19.8 |
| Dispersant | DISPERBYK 190 | 0.84 |
| Pigment | Calcium Carbonate | 8.36 |
| Expandable graphite | Nyagraph 251 | 8.36 |
| | Nyagraph 35 | 8.36 |
| Blowing agent | Melafine | 4.18 |
| Catalyst | Exolit AP 422 | 8.36 |
| Defoamer | BYK037 | 0.21 |
| Thickener | Natrosol 250 HR, 2% | 0.2 |
| | Part II | |
| Water | Water | 3.40 |
| Binders | Multibond 1P2 | 28.96 |
| | XB-91MO | 7.27 |
| Coalescing agent | NX 795 | 1.09 |
| Water softener | Sodium Polyphosphate, 10% | 0.63 |
| Thickener | Thixol 53L | 1.00 |

The materials from Part I were charged to a vessel while mixing. The mixture was covered with plastic or wax paper and was allowed to stand for one hour for the mixture to reach equilibrium. The mixture was then gently mixed to form a suspension. The suspension was then ground using a Dispermat at about 3500 rpm for about 20 minutes. After the grinding was completed, the materials from Part II were then charged to the vessel while mixing. The pH and viscosity were then measured. If necessary, the pH was adjusted to above 8.5. The mixture was then thickened with Rheotech 3800 rheology improver to achieve the desired thickness.

After preparing the fire resistant composition, an example pole cap sheet was prepared. The prepared pole cap sheets were then cut into a suitable shape-circles, hexagons, and octagons. The circle specimens investigated included a circle having circumference of about 16 inch (˜40 cm) or a circle having a circumference of about 24 inch (˜60 cm). The hexagon and octagon specimens investigated were cut by inscribing in a ˜16-inch (˜40-cm) square or a ˜24-inch (˜60-cm) square.

Various numbers of slits were evaluated for each specimen. For example, one or more slits were cut into the circle specimens, six slits were cut in the hexagon specimens, and eight slits were formed in octagon specimens. For the hexagon specimens and the octagon specimens, slits were investigated at the vertices and/or at locations in between adjacent vertices. Additionally, slits that were substantially centered between two adjacent vertices were examined.

The pole cap sheets were then installed onto pole ends of various diameters. Under the non-limiting conditions tested, the ˜16 inch (˜40 cm) specimens were suitable on, at least, pole ends having a diameter between about 7 inches and about 9.5 inches (˜18 cm to about 24 cm), inclusive. The pole cap sheets were also suitable on other pole end diameters.

The following example was used for installing the pole cap sheet, having an octagon shape, onto a wood pole end. For clarity, the example is discussed with reference to FIGS. 2A-2D, but should not be limited thereby. A pole cap sheet was positioned on the pole end 220 of the pole 210. Each member of the eight members 125-132 was pulled directly down the face 225 of the pole 210 and fastened to the face 225 of the pole 210 using staples as a fastener 215. A first portion of second member 126 was positioned under a portion of first member 125 and a second portion of second member 126 is positioned over a portion of third member 127, and so forth for the other members, so that a pinwheel configuration was formed around the pole end 220 of the pole 210. In this example, five staples were used per member securing two members, for a total of 40 staples.

Pole cap sheets and the resulting pole caps were assessed qualitatively. Here, parameters such as the amount of material extending from surfaces of the pole 210 after installation, the flatness of the surface of the installed pole cap (both the surface on the pole end 220 of the pole and the face 225 of the pole), and coverage of the pole end 220.

Each pole cap sheet proved to be well-secured to the pole end 220 and were fairly flat against the pole (material not extending too far off the pole 210), thereby significantly reducing the chance of snagging during handling of the pole, as well as during the installation of the pole at a work site. Under the conditions tested, it was also found pole caps sheets having a polygon shape performed better than circular shaped pole cap sheets in terms of, for example, forming a relatively flat surface on the pole end 220 and the face 225 of the pole 210, as well as coverage of the pole end 220. The polygon shaped pole sheets may therefore have less chance of snagging during handling of the pole, as well as during the installation of the pole at a work site.

It was also determined that, under the conditions tested, pole cap sheets having slits located in between adjacent vertices of the polygon-shaped pole cap sheet performed better than polygon-shaped pole cap sheets having slits located on the vertices.

After installation of the individual pole cap specimens, a wrap was positioned around the pole 210 and over a portion of the pole cap that projects down the face 225 of the pole 210. The resulting pole cap protection system was determined to provide excellent coverage of the pole and pole and very little chance of snagging during handling of the pole and installation of the pole at a work site.

Embodiments of the present disclosure generally relate to pole caps and pole protection systems for use in relation to utility poles. Embodiments of pole caps described herein are easy to install and can fit a wide range of pole end diameters, thereby reducing purchase and installation costs. Moreover, embodiments of pole caps described herein display excellent attachment to pole ends and provide superior protection from handling damage and environmental damage after installation on pole ends. Further, pole protection systems described herein can provide improved fire resistance and moisture protection to, for example, utility poles or other structures, relative to conventional technologies.

### Embodiments Listing

The present disclosure provides, among others, the following embodiments, each of which can be considered as optionally including any alternate embodiments:

Clause A1. A pole cap for installing on an end of a pole, comprising:
a body having a peripheral edge and a central portion; and
a plurality of slits in the body, the plurality of slits extending from the peripheral edge and toward the central portion of the body, the body comprising a multilayer structure, the multilayer structure comprising:
a polymer layer having a first surface and a second surface opposite the first surface, the second surface for facing the end of the pole;
a rubber containing layer disposed over the first surface of the polymer layer; and
a fire resistant composition disposed over the rubber containing layer.

Clause A2. The pole cap of Clause A1, wherein a first slit of the plurality of slits separates a first member and a second member of the body, the first member and second member being movable relative to one another into an overlapped configuration.

Clause A3. The pole cap of Clause A1 or Clause A2, wherein the plurality of slits comprises four to twelve slits.

Clause A4. The pole cap of any one of Clauses A1-A3, wherein:
the peripheral edge of the body is defined by a plurality of edges; and
the body has a shape of a polygon formed from the plurality of edges.

Clause A5. The pole cap of Clause A3, wherein a number of slits of the plurality of slits is equal to a number of edges of the plurality of edges.

Clause A6. The pole cap of Clause A4 or Clause A5, wherein each slit of the plurality of slits is positioned between two adjacent vertices of the polygon.

Clause A7. The pole cap of Clause A6, wherein each slit of the plurality of slits is positioned at a location that is substantially centered between two adjacent vertices of the polygon.

Clause A8. The pole cap of any one of Clauses A1-A7, wherein the body is substantially circular.

Clause A9. The pole cap of any one of Clauses A1-A8, wherein the fire resistant composition comprises or is derived from:
an intumescent compound;
a binder comprising a thermoplastic compound and a thermoset compound;
a catalyst; and
a blowing agent.

Clause A10. The pole cap of Clause A9, wherein a weight ratio of the thermoplastic compound to the thermoset compound is in a range of about 10:1 to about 1:3.

Clause A11. The pole cap of any one of Clauses A1-A10, wherein the polymer layer comprises a polymer formed from at least one C2 to C40 alpha-olefin.

Clause A12. The pole cap of Clause A11, wherein the at least one C2 to C40 alpha-olefin is ethylene, propylene, or both.

Clause A13. The pole cap of Clause A11 or Clause A12, wherein the polymer layer comprises polypropylene.

Clause B1. A pole cap for coupling to an end of a pole, the pole cap comprising:
a body having a peripheral edge and a central portion, the peripheral edge defined by a plurality of edges; and
a plurality of slits in the body, the plurality of slits extending from the peripheral edge and toward the central portion of the body, each slit of the plurality of slits extending from each edge of the plurality of edges, the plurality of slits forming a plurality of members, the plurality of members being movable relative to one another into an overlapped configuration, wherein the body comprises a multilayer structure, the multilayer structure comprising:
   a polymer layer having a first surface and a second surface opposite the first surface, the second surface for facing the end of the pole;
   a rubber containing layer having a first surface and a second surface, the second surface of the rubber containing layer disposed over the first surface of the polymer layer; and
   a coating disposed over the first surface of the rubber containing layer, the coating comprising a fire resistant composition, the fire resistant composition comprising:
      an intumescent compound; and
      a binder comprising a thermoplastic compound and a thermoset compound.

Clause B2. The pole cap of Clause B1, wherein the plurality of slits comprises four to twelve slits.

Clause B3. The pole cap of Clause B1 or Clause B2, wherein a number of slits of the plurality of slits is equal to a number of edges of the plurality of edges.

Clause B4. The pole cap of any one of Clauses B1-B3, wherein the body has a shape of a polygon, the polygon formed from the plurality of edges.

Clause B5. The pole cap of Clause B4, wherein each slit of the plurality of slits is positioned between a different pair of two adjacent vertices of the polygon.

Clause C1. A pole protection system, comprising:
a pole cap for mounting to an end of a pole, the pole cap comprising:
   a body having a peripheral edge and a central portion; and
   a plurality of slits in the body, the plurality of slits extending from the peripheral edge and toward the central portion of the body, the body comprising a multilayer structure, the multilayer structure comprising:
      a polymer layer having a first surface and a second surface opposite the first surface, the second surface for facing the end of the pole;
      a rubber containing layer, the rubber containing layer disposed over the first surface of the polymer layer; and
      a coating disposed over the first surface of the rubber containing layer, the coating comprising a first fire resistant composition; and
a wrap for covering a face of the pole, the wrap comprising:
   a substrate; and
   a coating disposed over the substrate, the coating comprising a second fire resistant composition, the first and second fire resistant compositions being the same or different.

Clause C2. The pole protection system of Clause C1, wherein:
the peripheral edge of the body is defined by a plurality of edges;
the body is the shape of a polygon formed from the plurality of edges; and
each slit of the plurality of slits is positioned between a different pair of two adjacent vertices of the polygon.

As is apparent from the foregoing general description and the specific embodiments, while forms of the embodiments have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, element, or elements and vice versa, such as the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

The use of headings is for purposes of convenience only and does not limit the scope of the present disclosure.

Where isomers of a named molecule group exist (for example, n-butyl, iso-butyl, sec-butyl, and tert-butyl), reference to one member of the group (for example, n-butyl) shall expressly disclose the remaining isomers (for example, iso-butyl, sec-butyl, and tert-butyl) in the family. Likewise, reference to a named molecule without specifying a particular isomer (for example, butyl) expressly discloses all isomers (for example, n-butyl, iso-butyl, sec-butyl, and tert-butyl).

As used herein, the term “about” when referring to a measurable value such as an amount, a temporal duration, and the like, is meant to encompass variations of ±20%, ±15, ±10%, ±5%, ±1%, or ±0.1% from the specified value, as such variations are appropriate.

As used herein, the indefinite article “a” or “an” shall mean “at least one” unless specified to the contrary or the context clearly indicates otherwise. For example, embodiments comprising “a slit” include embodiments comprising one, two, or more slits, unless specified to the contrary or the context clearly indicates only one slit is included.

As used herein, the term “coupled” means the joining of two elements directly or indirectly to one another.

While the foregoing is directed to embodiments of the present disclosure, other and further embodiments of the disclosure may be devised without departing from the basic scope thereof, and the scope thereof is determined by the claims that follow.

What is claimed is:

1. A pole cap for installing on an end of a pole, comprising:
a body having a peripheral edge and a central portion; and
a plurality of slits in the body, the plurality of slits extending from the peripheral edge and toward the central portion of the body, the body comprising a multilayer structure, the multilayer structure comprising:
a polymer layer having a first surface and a second surface opposite the first surface, the second surface for facing the end of the pole; and
a rubber containing layer disposed over the first surface of the polymer layer; and
a fire resistant composition disposed over the rubber containing layer.

2. The pole cap of claim 1, wherein a first slit of the plurality of slits separates a first member and a second member of the body, the first member and second member being movable relative to one another into an overlapped configuration.

3. The pole cap of claim 1, wherein the plurality of slits comprises four to twelve slits.

4. The pole cap of claim 1, wherein:
the peripheral edge of the body is defined by a plurality of edges; and
the body has a shape of a polygon formed from the plurality of edges.

5. The pole cap of claim 4, wherein a number of slits of the plurality of slits is equal to a number of edges of the plurality of edges.

6. The pole cap of claim 4, wherein each slit of the plurality of slits is positioned between two adjacent vertices of the polygon.

7. The pole cap of claim 6, wherein each slit of the plurality of slits is positioned at a location that is substantially centered between two adjacent vertices of the polygon.

8. The pole cap of claim 1, wherein the body is substantially circular.

9. The pole cap of claim 1, wherein the fire resistant composition comprises or is derived from:
an intumescent compound;
a binder comprising a thermoplastic compound and a thermoset compound;
a catalyst; and
a blowing agent.

10. The pole cap of claim 9, wherein a weight ratio of the thermoplastic compound to the thermoset compound is in a range of about 10:1 to about 1:3.

11. The pole cap of claim 1, wherein the polymer layer comprises a polymer formed from at least one C2 to C40 alpha-olefin.

12. The pole cap of claim 11, wherein the at least one C2 to C40 alpha-olefin is ethylene, propylene, or both.

13. The pole cap of claim 11, wherein the polymer layer comprises polypropylene.

14. A pole cap for coupling to an end of a pole, the pole cap comprising:
a body having a peripheral edge and a central portion, the peripheral edge defined by a plurality of edges; and
a plurality of slits in the body, the plurality of slits extending from the peripheral edge and toward the central portion of the body, each slit of the plurality of slits extending from each edge of the plurality of edges, the plurality of slits forming a plurality of members, the plurality of members being movable relative to one another into an overlapped configuration, wherein the body comprises a multilayer structure, the multilayer structure comprising:
a polymer layer having a first surface and a second surface opposite the first surface, the second surface for facing the end of the pole;
a rubber containing layer having a first surface and a second surface, the second surface of the rubber containing layer disposed over the first surface of the polymer layer; and
a coating disposed over the first surface of the rubber containing layer, the coating comprising a fire resistant composition, the fire resistant composition comprising:
an intumescent compound; and
a binder comprising a thermoplastic compound and a thermoset compound.

15. The pole cap of claim 14, wherein the plurality of slits comprises four to twelve slits.

16. The pole cap of claim 14, wherein a number of slits of the plurality of slits is equal to a number of edges of the plurality of edges.

17. The pole cap of claim 14, wherein the body has a shape of a polygon, the polygon formed from the plurality of edges.

18. The pole cap of claim 17, wherein each slit of the plurality of slits is positioned between a different pair of two adjacent vertices of the polygon.

19. A pole protection system, comprising:
a pole cap for mounting to an end of a pole, the pole cap comprising:
a body having a peripheral edge and a central portion; and
a plurality of slits in the body, the plurality of slits extending from the peripheral edge and toward the central portion of the body, the body comprising a multilayer structure, the multilayer structure comprising:
a polymer layer having a first surface and a second surface opposite the first surface, the second surface for facing the end of the pole;
a rubber containing layer, the rubber containing layer disposed over the first surface of the polymer layer; and
a coating disposed over the first surface of the rubber containing layer, the coating comprising a first fire resistant composition; and
a wrap for covering a face of the pole, the wrap comprising:
a substrate; and
a coating disposed over the substrate, the coating comprising a second fire resistant composition, the first and second fire resistant compositions being the same or different.

20. The pole protection system of claim 19, wherein:
the peripheral edge of the body is defined by a plurality of edges;
the body is the shape of a polygon formed from the plurality of edges; and
each slit of the plurality of slits is positioned between a different pair of two adjacent vertices of the polygon.
